(19) United States
(12) Patent Application Publication
(10) Pub. No.: US 2012/0117838 A1
(43) Pub. Date: May 17, 2012

(54) Portable Message Panel System

(76) Inventor: Hugh Riley, Newnan, GA (US)

(21) Appl. No.: 12/948,456

(22) Filed: Nov. 17, 2010

(51) Int. Cl. G09F 13/16; G09F 7/00; G09F 17/00

(52) U.S. Cl. 40/582; 40/603

(57) ABSTRACT

A portable message panel system is provided, comprising at least one message panel, wherein each panel includes a coilable frame member having a folded and an unfolded orientation. A fabric material covers selected portions of the frame member to form the panel, the fabric material held taut within the frame member when assuming the unfolded orientation of the frame member, so that the fabric material extends in a flat planar configuration when the frame member is in its unfolded orientation. A message is located on the fabric material and comprises one or more alphanumeric characters, symbols, or icons. Fasteners on each panel enable more complex, multi-panel messages to be formed as needed.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON COMPACT DISC

Not applicable.

### BACKGROUND OF THE INVENTION

1. Field of the Invention

The present invention relates to portable panels used to convey a message or other information to persons in a wide variety of situations, and more particularly to such panels which can be quickly mounted to various surfaces or carried by a person.

2. Description of Related Art

A wide range of portable signs are used in many different circumstances. For example, directional devices such as arrows, signs, flash lights, signal lights, wands, strobes, or the like are often used to control the flow of traffic. These products are important safety devices when used to direct traffic during emergency situations which require police, fire fighters, medical assistance, or the like. Also, portable signs are used to convey messages to persons in commerce, such as the location of a particular retail store, the event of a sale of certain products or services, or to alert persons to activities in which they may be interested.

In the case of traffic control or emergency situations, such situations can develop quickly, and they often require trained personnel to perform multiple tasks such as triage, interviews, medical assistance, or the like, in addition to traffic control. Therefore, directional devices that must be hand-held for proper use can unnecessarily tie up essential personnel, or waste precious time. A typical version of a prior art directional device with this type of problem is disclosed in U.S. Pat. No. 5,079,679. This prior art invention describes a traffic director's stick which performs multiple functions, but must always be operated by hand.

Furthermore, many directional devices such as signs, or arrows mounted on signs, are not compact enough to be carried as standard equipment in most emergency vehicles. Consequently, such devices are often transported to the scene of an emergency long after the initial trained personnel (or “first responders”) have arrived. This also wastes time and puts essential personnel at unnecessary risk.

Additionally, portable directional devices must be capable of being used in a variety of different weather conditions, and at any time during the day or night. Such portable directional devices often require lighting to be seen properly. In order to power the lighting and preserve portability, batteries are most often used. However, batteries will run out and have to be replaced or recharged, which again takes more time, can put personnel at risk, and costs money.

For the above reasons, law enforcement personnel, first responders, stranded motorists, and other persons have a great need for directional or instructional signage that satisfies at least the following important criteria: (a) portability, (b) low cost, (c) high visibility, (d) no electrical power required, (e) versatility to create more complex, multi-message displays, and (f) ability to quickly mount on any vehicles and other surfaces.

As can be appreciated, the aforementioned qualities of such signage are also ideal for many commercial applications as well. The dynamics of business in a fast-paced economy require that business owners quickly and inexpensively announce events, such as sales or specials, to pedestrians or motorists. The ability to display such information on existing storefronts or adjacent structures without architectural modifications can present a distinct advantage when time and money are scarce.

In the past, various forms of panel systems have been proposed, and some of which might be suitable in meeting the objectives described above. However, those panel systems which carry the best promise for such purposes are the ones which employ a flexible material wrapped over the perimeter of a bendable rim. Several variants of such panels are U.S. Pat. No. 5,024,262 to Huang; U.S. Pat. No. 5,116,273 to Chan; and U.S. Pat. No. 6,192,635 to Zheng. While those panels are effective for their stated purposes, they lack specific functional and structural features which are ideal for use with traffic control, motorists, and other commercial applications.

### SUMMARY OF THE INVENTION

Therefore, a portable message panel system is provided, comprising at least one message panel, wherein each panel includes a coilable frame member having a folded and an unfolded orientation; a fabric material covering selected portions of the frame member to form the panel, the fabric material held taut within the frame member when assuming the unfolded orientation of the frame member, so that the fabric material extends in a flat planar configuration when the frame member is in its unfolded orientation; and a message located on the fabric material.

In a preferred embodiment, the fabric material includes one or more hook-and-loop fastening straps extending from the panel. In another embodiment, or in addition to the fastening straps, the fabric material includes one or more reinforced holes formed into the fabric material.

To facilitate the use of two or more panels together, another embodiment of the present invention is provided wherein the fabric material includes one or more quick-release buckles adapted to engage other panels to form a multi-panel assembly.

With regard to the message on the fabric material, the message may be formed with a reflective material, and it may comprise a wide range of messages, including but not limited to alphanumeric characters, directional symbols, warning symbols, and other informational data.

Optionally, the fabric material may also include a flexible hand grip, which can be used by persons holding such panels for others to see, such as law enforcement officers, first responders, and similar personnel.

Preferably, the fabric material includes at least one slot formed therein, and an attachment strap adapted to engage the slot, wherein the attachment strap comprises a first end and a second end, and wherein each of the first end and the second end are shaped to prevent the attachment strap from inadvertently being removed from the slot.

For the purpose of mounting the panels to a desired location, the panels may include one or more mounting brackets, wherein the mounting bracket comprises a base having one or more suction devices adapted for adhering to a surface; and a clamping device adapted to grip the panel.

More preferably, the clamping device on the mounting base pivots relative to the base, and it may further include means for biasing the panel to a predetermined position.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements.

FIG. 1 shows a front view of a message panel in accordance with a preferred embodiment of the present invention.

FIG. 2 shows a rear view of the message panel of FIG. 1.

FIG. 3 shows an overlay panel that can be used to place over the main panel and display an alternate message.

FIG. 4 shows an attachment strap used to mount the panel to vehicle windows, doors, and other objects.

FIG. 5 shows a side cross-sectional view of the manner in which a panel may be attached to a vehicle window using the attachment strap.

FIG. 6 shows multiple panels attached to one another by fasteners to create a more complex, multi-panel message.

FIGS. 7A and 7B show a proposed panel mount for displaying the panel from a surface.

### DETAILED DESCRIPTION OF THE INVENTION

Before the subject invention is further described, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

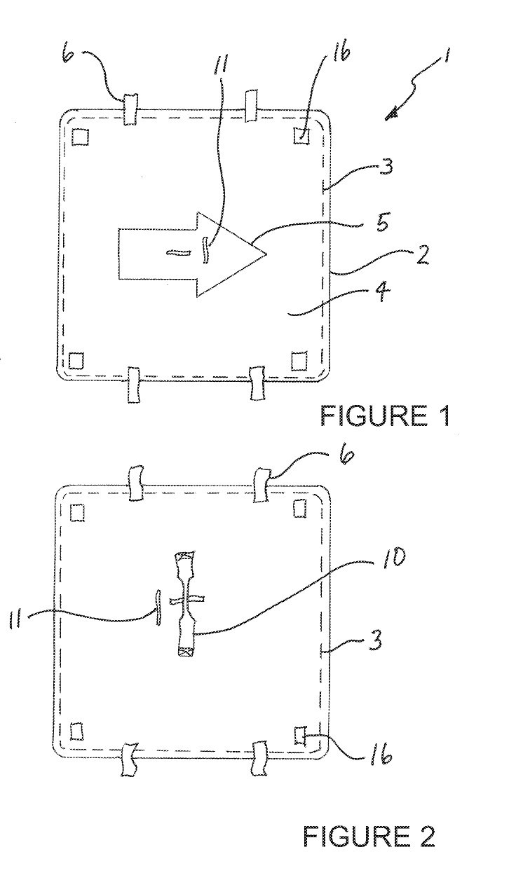

Turning now to FIGS. 1 and 2, in a preferred embodiment of the present invention, a portable message panel system 1 is shown, comprising at least one message panel 2, wherein each panel 2 includes a coilable frame member 3 having a folded and an unfolded orientation. A fabric material 4 covers selected portions of the frame member 3 to form the panel 2, and the fabric material 4 held taut within the frame member 3 when assuming the unfolded orientation of the frame member 3, so that the fabric material 4 extends in a flat planar configuration when the frame member 3 is in its unfolded orientation. The general construction of the panel from the frame member 3 and the fabric material 4 is known to those in the art, and is more fully described in a number of other patents, namely U.S. Pat. No. 5,024,262 to Huang; U.S. Pat. No. 5,116,273 to Chan; and U.S. Pat. No. 6,192,635 to Zheng; the disclosures of which are incorporated herein by reference.

A message 5 is located on the fabric material 4, and will usually be formed of a material that is attached to the fabric material 4 either by adhesive or stitching. The message 5 may comprise alphanumeric characters, directional symbols, warning symbols, or any other indicia capable of providing information or direction to a person viewing the panel 2. For example, typical traffic control symbols such as directional arrows, stop signs, yield signs, and the like would be ideal for law enforcement or other personnel in a variety of situations. Likewise, a stranded motorist would find much use for messages such as “Need Tow”, “Need Gas”, or similar messages. A range of other messages, symbols, or icons may also be employed for a range of commercial uses, such as a coffee cup for a coffee shop, the word “Sale” for sale items or other specials in a retail store, or an “Open” or “Closed” phrase.

Particularly in the case of nighttime use with vehicle traffic or emergency situations, it is preferred that the message 5 be formed of a reflective material, so that maximum visibility is achieved.

Having described the basic construction of the panels 2, a number of other novel features will be described which relate to how the panels 2 can be mounted or used in a practical situation. In a preferred embodiment, the fabric material 4 includes one or more hook-and-loop fastening straps 6 extending from the panel 2. In a typical configuration, at least two such fastening straps 6 are located near the top of the panel 2, while another two such fastening straps 6 are located near the bottom of the panel 2, best shown in FIGS. 1 and 2. Each such strap 6 includes both hook and loop portions so that the straps 6 can be wrapped around poles, bars, or other objects available to the user.

Optionally, as shown in FIG. 6, the fabric material 4 may also include one or more reinforced holes 7 formed into the fabric material 4. Such holes 7 may employ conventional grommets or other fabric reinforcement such that elastic cords or strings can be used to attach the panel 2 to nearby objects.

In a more preferred embodiment, the fabric material 4 includes one or more flexible hand grips 10 attached to the rear side of the panel 2, best shown in FIG. 2. The hand grip 10 may easily be used to hold the panel 2 by hand if there are no other objects for mounting the panel 2. As will be understood, the size of the hand grip 10 may be adjusted to accommodate the hand or forearm, as needed.

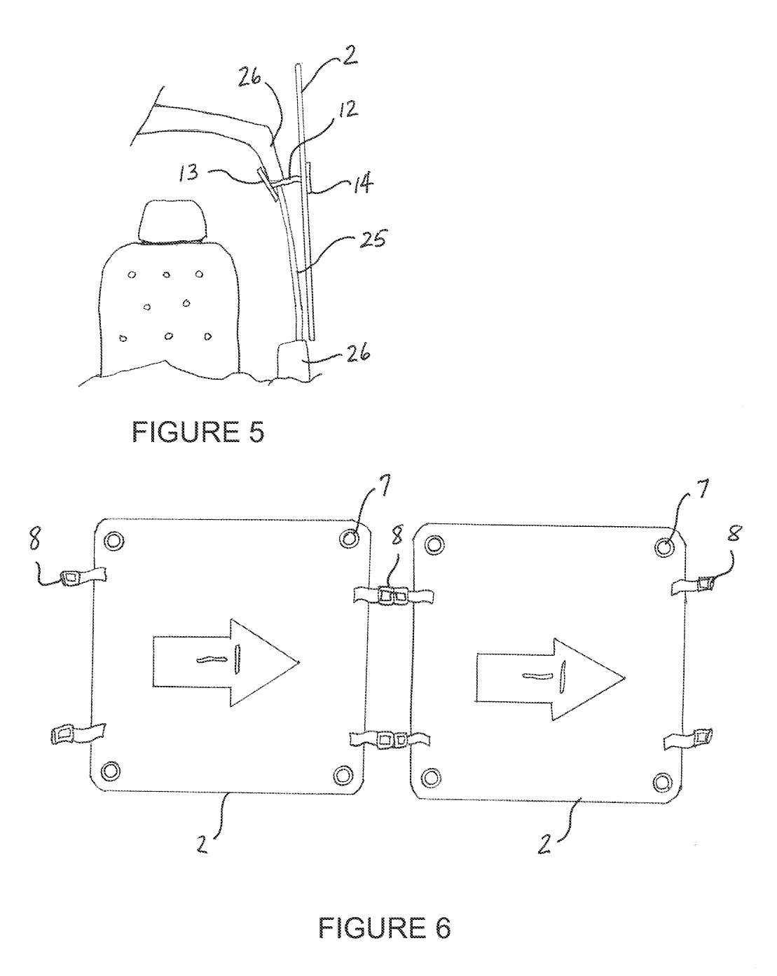

To permit convenient mounting of the panel 2 to a vehicle window or door, the fabric material 4 may also include at least one slot 11 formed therein. Preferably, at least two such slots 11 are provided, one horizontal and one vertical, in the center of the fabric material 4. These slots 11 function as “button holes” which can receive an attachment strap 12 adapted to engage the slot 11. The attachment strap 12 includes a first end 13 and a second end 14, and wherein each of the first end 13 and the second end 14 are flexibly attached to the strap 12, and are shaped to resist being inadvertently being removed from the slot 11 after insertion. For example, in operation of this mounting method, first end 13 is laid flat against the strap 12 and inserted through slot 11 until the first end 13 is completely on the opposite side of the panel 2 from the side of its insertion. Now that the strap 12 is held within the slot 11, the first end 13 (if present on the rear side of the panel 2) can be captured between a vehicle window 25 and the door frame 26, as shown in FIG. 5. Thus, because the second end 14 of the strap 12 is prevented from passing through slot 11, the panel 2 is effectively suspended from the vehicle. A similar result can be achieved by capturing the strap 12 between the door and the vehicle body, or any other location on the vehicle which allows a similar closure.

To achieve more complex, multi-panel messages, the fabric material 4 may also include one or more quick-release buckles or similar fasteners 8, as shown in FIG. 6. In the embodiment shown, each panel 2 includes two fasteners 8 on the left (male) and right (female) of the material 4. Thus, an identically configured second panel may be securely attached to the first panel. It should be appreciated that any number of such panels 2 may be attached in this manner, and that the multi-panel displays can be oriented horizontally, vertically, or in any other direction, depending on the precise location of the fasteners 8. Although the embodiment of FIG. 6 shows two directional arrows, each of the panels may have its own message, symbol, or icon to create more complex messages as needed for the particular situation. For example, a supply of panels, each having an alphanumeric character may be combined to spell an instruction to an approaching vehicle, such as “T-U-R-N”, using four panels 2. The variations and possible combinations are limited only by the number and diversity of panels available to the user, as well as by the available attachment locations.

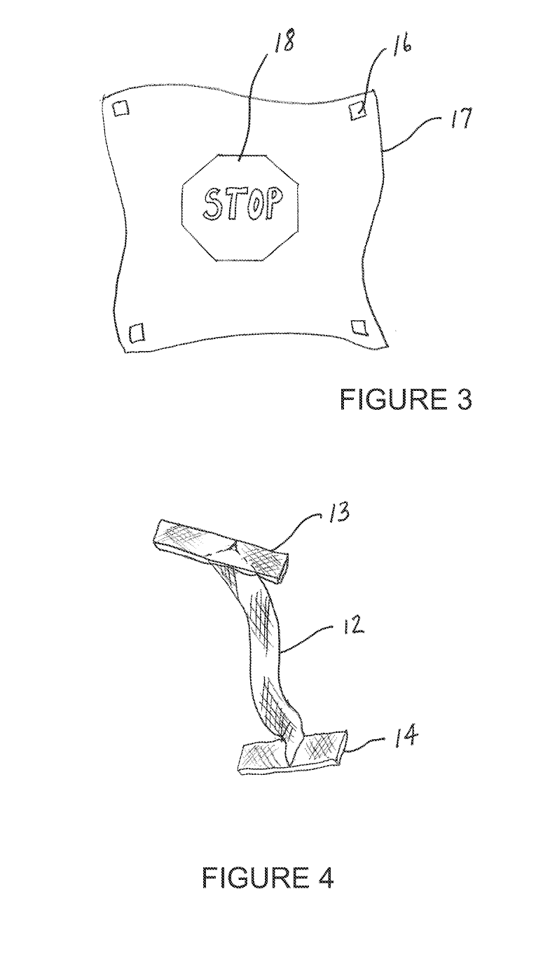

Optionally, and as best shown in FIGS. 1 and 3, each panel 2 may further include one or more overlay fasteners 16 for receiving an overlay panel 17, so that the overlay panel 17 can be attached to the overlay fasteners 16. In other words, opposing snaps or hook and loop fasteners may be employed so that the overlay panel 17 can cover the message 5 on the fabric material 4. In many cases, the overlay panel 17 may have an alternate message 18 so that the original message 5 can be completely replaced. For example, a directional arrow can be changed to a STOP sign without dismounting the panel 2 from the vehicle. Importantly, the overlay panel 17 does not need to have its own frame member 3. It can simply comprise a portion of fabric material with its own alternative message 18, and it is merely attached to the panel 2 via the fasteners 16. This arrangement finds particular utility in traffic or other circumstances that change frequently based on conditions in the field.

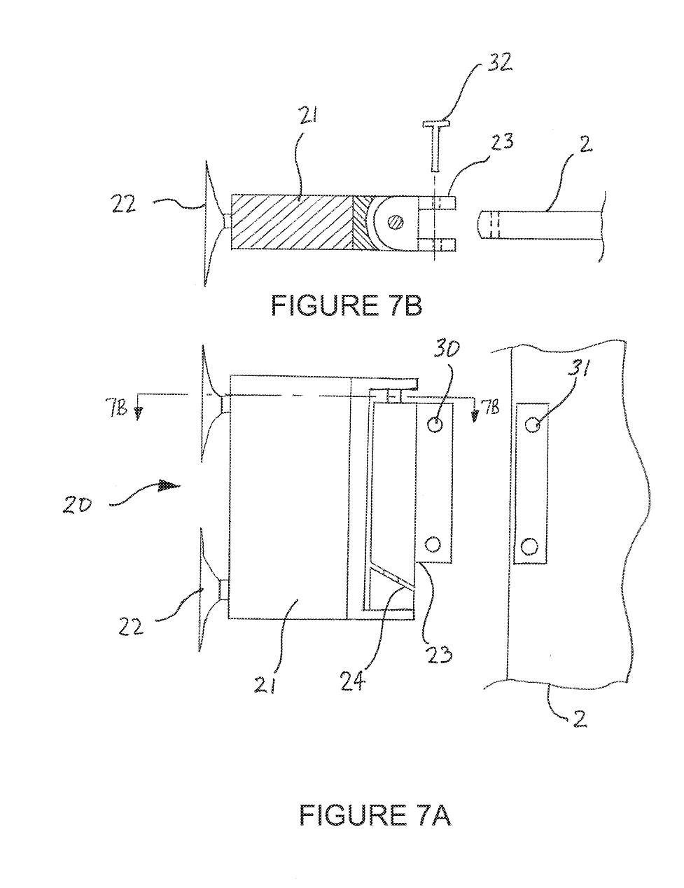

Finally, an alternative means for mounting the panel is also provided, including one or more mounting brackets 20, as shown in FIGS. 7A and 7B. Each mounting bracket 20 comprises a base 21 having one or more suction devices 22 adapted for adhering to a smooth surface. A clamping device 23 is pivotally attached to the base 21, and the clamping device 23 is adapted to grip the panel 2. Preferably, the clamping device 23 pivots relative to the base 21, and further includes means 24 for biasing the panel 2 to a predetermined position. For example, the device of FIG. 7A depicts a cam surface, such that if the clamping device 23 is caused to rotate away from the desired position (perpendicular from the mount), perhaps by wind or other force, then the effect of gravity will urge the clamping device 23 back to its original position. Clamping device 23 is shown to include a pair of mounting holes 30 which match a reinforced hole pattern 31 on the panel 2. Pins 32 or similar dowels or pegs can be inserted into the clamping device 23 and through the panel holes 31 to retain the panel 2. However, it should be understood that any number of clamping arrangements may be equally suitable, including spring biased clamps and similar devices, with the goal of securely holding the panel 2.

All references cited in this specification are herein incorporated by reference as though each reference was specifically and individually indicated to be incorporated by reference. The citation of any reference is for its disclosure prior to the filing date and should not be construed as an admission that the present invention is not entitled to antedate such reference by virtue of prior invention.

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only; the scope of the present invention is to be limited only by the following claims.

The invention claimed is:

1. A portable message panel system, comprising at least one message panel, wherein each panel includes:
(a) a coilable frame member having a folded and an unfolded orientation;
(b) a fabric material covering selected portions of the frame member to form the panel, the fabric material held taut within the frame member when assuming the unfolded orientation of the frame member, so that the fabric material extends in a flat planar configuration when the frame member is in its unfolded orientation; and
(c) a message located on the fabric material.

2. The device of claim 1, wherein the fabric material includes one or more hook-and-loop fastening straps extending from the panel.

3. The device of claim 1, wherein the fabric material includes one or more reinforced holes formed into the fabric material.

4. The device of claim 1, wherein the fabric material includes one or more quick-release buckles adapted to engage other panels to form a multi-panel assembly.

5. The device of claim 1, wherein the message is formed with a reflective material.

6. The device of claim 1, wherein the message comprises alphanumeric characters.

7. The device of claim 1, wherein the message includes directional symbols.

8. The device of claim 1, wherein the message includes warning symbols.

9. The device of claim 1, wherein the fabric material includes a flexible hand grip.

10. The device of claim 1, wherein the fabric material includes at least one slot formed therein, and an attachment strap adapted to engage the slot, wherein the attachment strap comprises a first end and a second end, and wherein each of the first end and the second end are shaped to prevent the attachment strap from inadvertently being removed from the slot.

11. The device of claim 1, wherein each panel further includes:
(a) one or more overlay fasteners for receiving an overlay panel; and
(b) an overlay panel attached to the overlay fasteners, wherein the overlay panel covers the message on the fabric material.

12. The device of claim 11, wherein the overlay panel includes an alternate message.

13. The device of claim 1, further including one or more mounting brackets, wherein the mounting bracket comprises:
(a) a base having one or more suction devices adapted for adhering to a surface; and
(b) a clamping device adapted to grip the panel.

14. The device of claim 13, wherein the clamping device pivots relative to the base.

15. The device of claim 13, wherein the clamping device pivots relative to the base, and further includes means for biasing the panel to a predetermined position.
